(19) United States
(12) Patent Application Publication
(10) Pub. No.: US 2011/0147389 A1
(43) Pub. Date: Jun. 23, 2011

(54) Paper Baking Utensil

(76) Inventor: Feng-Hsin Huang, Tainan City (TW)

(21) Appl. No.: 12/644,449

(22) Filed: Dec. 22, 2009

(51) Int. Cl. A47J 37/01

(52) U.S. Cl. 220/573.1

(57) ABSTRACT

A paper baking utensil includes a baking body and a plurality of connections mounted on the baking body. The baking body has an upright peripheral wall formed with a plurality of folded edges and a plurality of mounting holes. Each of the connections is mounted on and extended through a respective one of the folded edges of the baking body so as to support the respective folded edge of the baking body. Thus, the paper baking utensil has a lighter weight, has a lower price of fabrication, is made easily and quickly and can be used successively.

### BACKGROUND OF THE INVENTION

1. Field of the Invention

The present invention relates to a baking utensil and, more particularly, to a paper baking utensil for placing and baking foods.

2. Description of the Related Art

A conventional baking utensil comprises a support frame and a tray mounted in the support frame to place a food, such as a cake. The support frame is made of metallic material. The support frame has an upper portion having a periphery provided with a support flange. The support frame has a hollow lower portion. The tray is made of silicone. The tray has an upper portion having a periphery provided with a bent lip abutting the support flange of the support frame and a lower portion protruding from the hollow lower portion of the support frame. Thus, when the baking process is accomplished, the lower portion of the tray is pushed upward to detach the lip of the tray from the support flange of the support frame and to detach the tray from the support frame. However, the support frame is made of metallic material having a greater heating conducting effect so that a user is easily burned or scalded by the support frame at a higher temperature, thereby causing danger to the user when touching the support frame. In addition, the support frame made of metallic material has a heavier weight and a higher cost of fabrication.

### BRIEF SUMMARY OF THE INVENTION

In accordance with the present invention, there is provided a paper baking utensil, comprising a baking body and a plurality of connections mounted on the baking body. The baking body has an upright peripheral wall formed with a plurality of folded edges and a plurality of mounting holes. Each of the connections is mounted on and extended through a respective one of the folded edges of the baking body so as to support the respective folded edge of the baking body.

The primary objective of the present invention is to provide a paper baking utensil that has a lighter weight, has a lower price of fabrication, is made easily and quickly and can be used successively.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a paper baking utensil in accordance with the preferred embodiment of the present invention.

FIG. 2 is a partially exploded perspective view of the paper baking utensil as shown in FIG. 1.

FIG. 3 is a locally enlarged view of the paper baking utensil taken along circle “A” as shown in FIG. 2.

FIG. 4 is a side cross-sectional assembly view of the paper baking utensil as shown in FIG. 3.

FIG. 5 is a perspective view of a baking body of the paper baking utensil as shown in FIG. 1.

FIG. 6 is a cross-sectional view showing fabrication of the baking body of the paper baking utensil as shown in FIG. 5.

FIG. 7 is a side cross-sectional assembly view of a paper baking utensil in accordance with another preferred embodiment of the present invention.

FIG. 8 is an exploded cross-sectional view of the paper baking utensil as shown in FIG. 7.

FIG. 9 is a perspective view of a paper baking utensil in accordance with another preferred embodiment of the present invention.

### DETAILED DESCRIPTION OF THE INVENTION

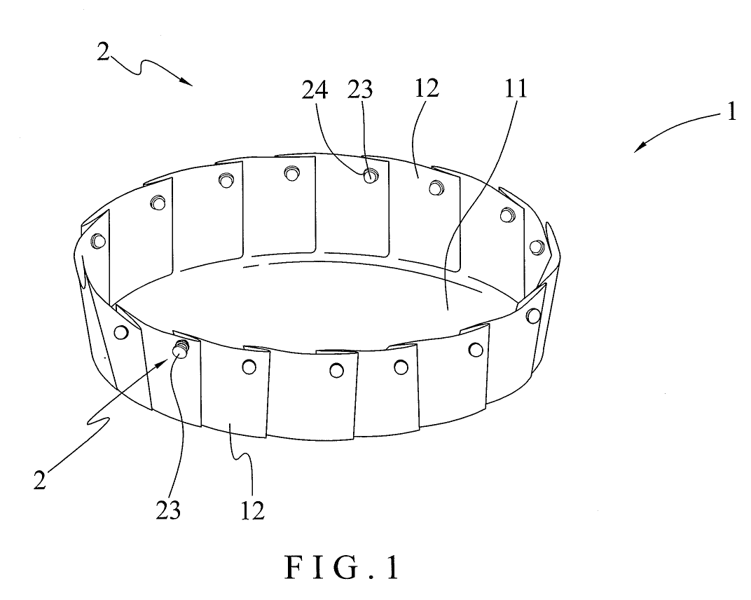

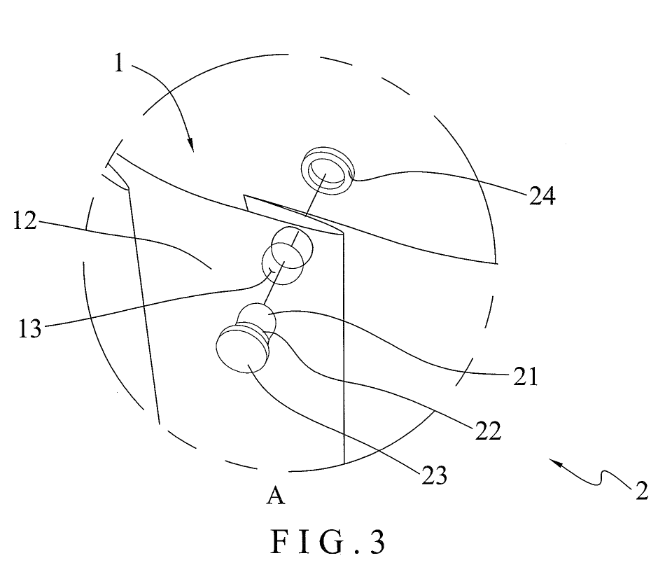

Referring to the drawings and initially to FIGS. 1-5, a paper baking utensil in accordance with the preferred embodiment of the present invention comprises a baking body 1 and a plurality of connections 2 mounted on the baking body 1.

The baking body 1 is a sheet plate made of paper that can be reused or decomposed to satisfy the environmental protection purpose. The baking body 1 is bent and folded to have a disk shape. The baking body 1 has a substantially U-shaped cross-sectional profile. The baking body 1 has a bottom wall 11 and has an upright peripheral wall surrounding the bottom wall 11 and formed with a plurality of folded edges 12 and a plurality of mounting holes 13. Preferably, any two of the folded edges 12 of the baking body 1 overlap each other, and each of the mounting holes 13 of the baking body 1 is formed in an overlapping portion of any two folded edges 12 of the baking body 1.

Each of the connections 2 is mounted on and extended through a respective one of the folded edges 12 of the baking body 1 so as to support the respective folded edge 12 of the baking body 1 exactly and stably. Each of the connections 2 includes a connecting member 22 mounted in a respective one of the mounting holes 13 of the baking body 1 and abutting the respective folded edge 12 of the baking body 1, and a washer 24 mounted on the connecting member 22 and abutting the respective folded edge 12 of the baking body 1. The connecting member 22 of each of the connections 2 has a first end provided with a fixing portion 23 protruding outwardly from a first end of the respective mounting hole 13 of the baking body 1 and abutting a first side of the respective folded edge 12 of the baking body 1 and a second end provided with a snapping portion 21 protruding outwardly from a second end of the respective mounting hole 13 of the baking body 1 and abutting a second side of the respective folded edge 12 of the baking body 1. The connecting member 22 of each of the connections 2 has a size smaller than that of the respective mounting hole 13 of the baking body 1 so that the connecting member 22 of each of the connections 2 is inserted into the respective mounting hole 13 of the baking body 1 easily. The fixing portion 23 of the connecting member 22 of each of the connections 2 is a circular piece and has a size greater than that of the respective mounting hole 13 of the baking body 1. The snapping portion 21 of the connecting member 22 of each of the connections 2 has a size greater than that of the respective mounting hole 13 of the baking body 1. The snapping portion 21 of the connecting member 22 of each of the connections 2 is made of a resilient material and has a substantially spherical profile to facilitate insertion of the snapping portion 21 into the respective mounting hole 13 of the baking body 1. The washer 24 of each of the connections 2 abuts the second side of the respective folded edge 12 of the baking body 1 and is located between the snapping portion 21 of the connecting member 22 and the second side of the respective folded edge 12 of the baking body 1 so that each of the folded edges 12 of the baking body 1 is clamped between the fixing portion 23 of the connecting member 22 and the washer 24 of the respective connection 2.

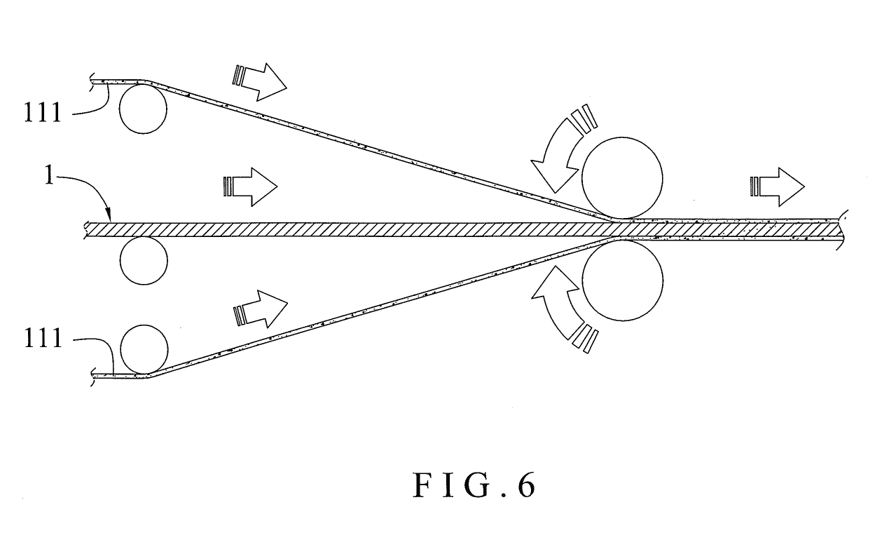

As shown in FIG. 6, the baking body 1 is expanded to have a flat shape before the baking body 1 is folded, and the paper baking utensil further comprises a coating layer 111 mounted on two opposite faces of the baking body 1 by coating, rolling or spraying so that the two opposite faces of the baking body 1 are non-sticky. Preferably, the coating layer 112 is made of a non-sticky material, such as silicone, Teflon and the like.

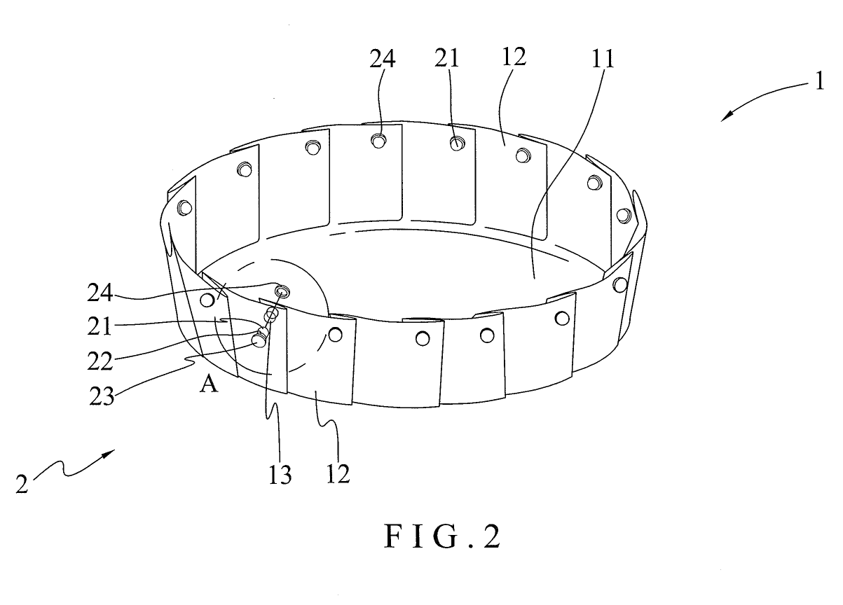

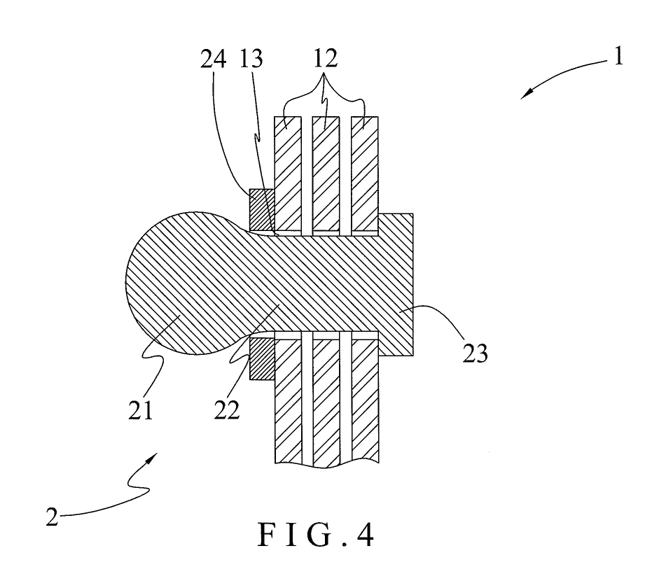

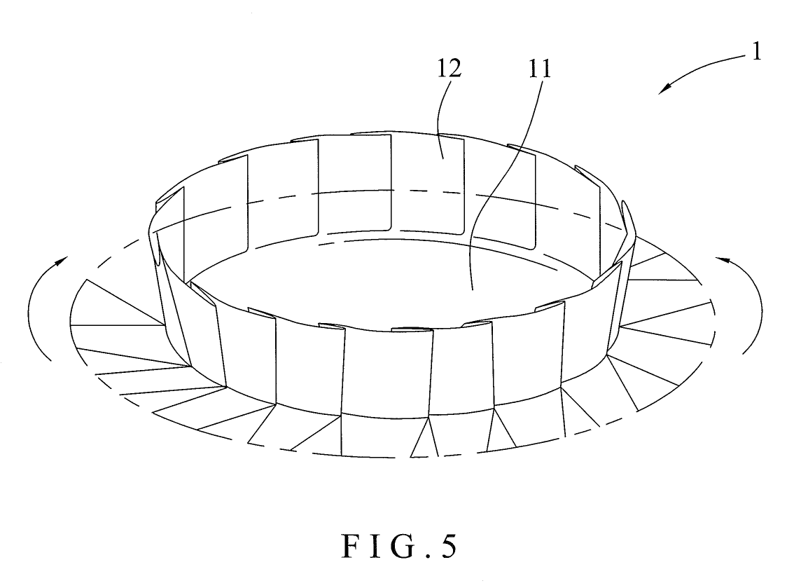

In assembly, still referring to FIGS. 1-5, the baking body 1 is bent and folded to have a disk shape and to form the folded edges 12 as shown in FIG. 5, wherein each of the mounting holes 13 of the baking body 1 is formed in a respective one of the folded edges 12 of the baking body 1 as shown in FIG. 2. Then, the snapping portion 21 of the connecting member 22 of each of the connections 2 is inserted through the respective mounting hole 13 of the baking body 1 and the washer 24 so that the snapping portion 21 of the connecting member 22 of each of the connections 2 protrudes outwardly from the second end of the respective mounting hole 13, and the fixing portion 23 of the connecting member 22 of each of the connections 2 protrudes outwardly from the first end of the respective mounting hole 13 to attach each of the connections 2 to the respective folded edge 12 of the baking body 1. Thus, each of the folded edges 12 of the baking body 1 is clamped between the fixing portion 23 of the connecting member 22 and the washer 24 of the respective connection 2 as shown in FIG. 4 so that each of the folded edges 12 of the baking body 1 is limited and fixed by the respective connection 2 so as to prevent the folded edges 12 of the baking body 1 from being deformed or distorted.

In practice, a food, such as a cake and the like, to be baked is placed into the baking body 1. At this time, each of the folded edges 12 of the baking body 1 is limited and fixed by the respective connection 2 so as to prevent the folded edges 12 of the baking body 1 from being deformed or distorted. Then, the baking body 1 together with the food is placed into an oven so that the food can be baked in the oven. When the baking process is finished, the baking body 1 together with the food is removed from the oven.

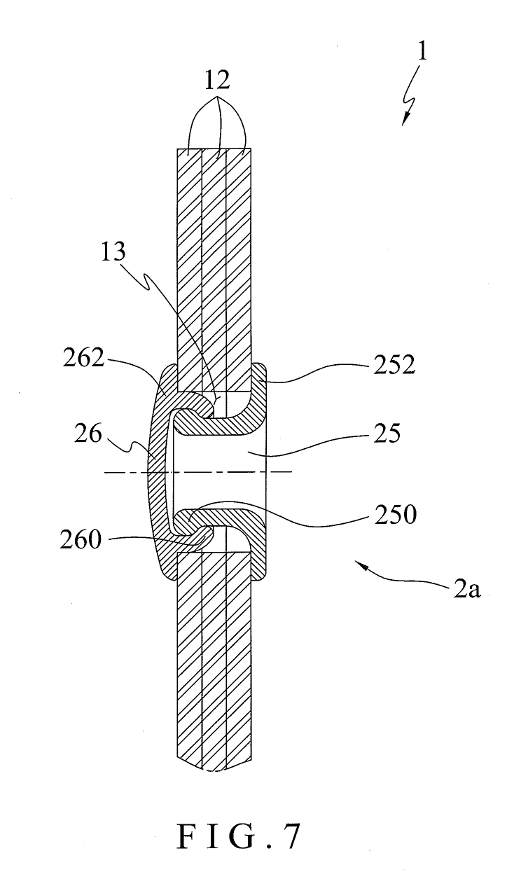

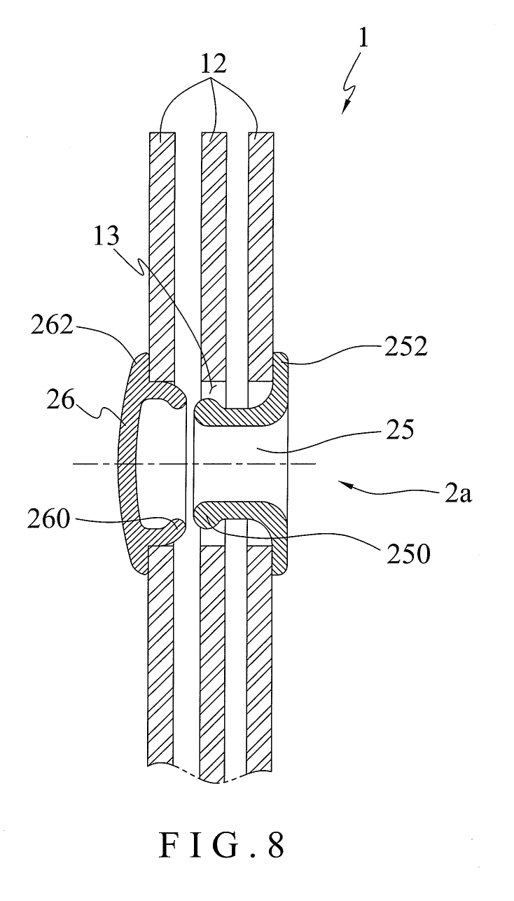

Referring to FIGS. 7 and 8, each of the connections 2a includes a first snapping member 25 abutting a first side of the respective folded edge 12 of the baking body 1, and a second snapping member 26 abutting a second side of the respective folded edge 12 of the baking body 1 and combined with the first snapping member 25. The first snapping member 25 of each of the connections 2a has a first end provided with a first locking hook 250 inserted into a respective one of the mounting holes 13 of the baking body 1 and a second end provided with a first press portion 252 abutting the first side of the respective folded edge 12 of the baking body 1. The first press portion 252 of the first snapping member 25 of each of the connections 2a protrudes outwardly from a first end of the respective mounting hole 13 of the baking body 1. The second snapping member 26 of each of the connections 2a has a first end provided with a second locking hook 260 inserted into a respective one of the mounting holes 13 of the baking body 1 and releasably locked onto the first locking hook 250 of the first snapping member 25 and a second end provided with a second press portion 262 abutting the second side of the respective folded edge 12 of the baking body 1. The second press portion 262 of the second snapping member 26 of each of the connections 2a protrudes outwardly from a second end of the respective mounting hole 13 of the baking body 1.

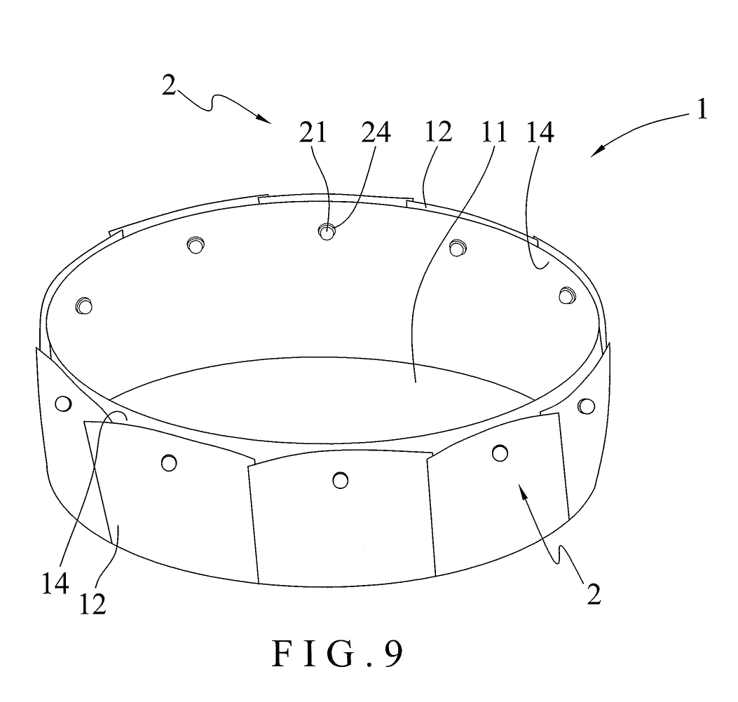

Referring to FIG. 9, the paper baking utensil further comprises an inner board 14 mounted in the baking body 1 and abutting the folded edges 12 of the baking body 1, and each of the connections 2 extends through the inner board 14 and a respective one of the folded edges 12 of the baking body 1 so as to combine the respective folded edge 12 of the baking body 1 with the inner board 14. The inner board 14 has an annular shape.

Accordingly, the connections 2 are mounted on the folded edges 12 of the baking body 1 so as to support the folded edges 12 of the baking body 1 exactly and stably. In addition, each of the folded edges 12 of the baking body 1 is clamped between the fixing portion 23 of the connecting member 22 and the washer 24 of the respective connection 2 so that each of the folded edges 12 of the baking body 1 is limited and fixed by the respective connection 2 so as to prevent the folded edges 12 of the baking body 1 from being deformed or distorted. Further, the baking body 1 has a lighter weight and has a lower price of fabrication. Further, the baking body 1 is made easily and quickly. Further, the baking body 1 is provided with a non-sticky coating layer 111 so that the baking body 1 can be used successively.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A paper baking utensil, comprising:
a baking body;
a plurality of connections mounted on the baking body; wherein:
the baking body is a sheet plate made of paper;
the baking body is bent and folded to have a disk shape;
the baking body has a bottom wall and has an upright peripheral wall surrounding the bottom wall and formed with a plurality of folded edges and a plurality of mounting holes;
any two of the folded edges of the baking body overlap each other;
each of the mounting holes of the baking body is formed in an overlapping portion of any two folded edges of the baking body;
each of the connections is mounted on and extended through a respective one of the folded edges of the baking body so as to support the respective folded edge of the baking body;
each of the connections includes a connecting member mounted in a respective one of the mounting holes of the baking body and abutting the respective folded edge of the baking body;
the connecting member of each of the connections has a first end provided with a fixing portion protruding outwardly from a first end of the respective mounting hole of the baking body and abutting a first side of the respective folded edge of the baking body and a second end provided with a snapping portion protruding outwardly from a second end of the respective mounting hole of the baking body and abutting a second side of the respective folded edge of the baking body.

2. The paper baking utensil of claim 1, wherein
the connecting member of each of the connections has a size smaller than that of the respective mounting hole of the baking body;
the fixing portion of the connecting member of each of the connections has a size greater than that of the respective mounting hole of the baking body;
the snapping portion of the connecting member of each of the connections has a size greater than that of the respective mounting hole of the baking body.

3. The paper baking utensil of claim 1, further comprising:
a coating layer mounted on two opposite faces of the baking body by coating so that the two opposite faces of the baking body are non-sticky;
wherein the coating layer is made of a non-sticky material of silicone and Teflon.

4. The paper baking utensil of claim 1, further comprising:
an inner board mounted in the baking body and abutting the folded edges of the baking body;
wherein each of the connections extends through the inner board and a respective one of the folded edges of the baking body so as to combine the respective folded edge of the baking body with the inner board.

5. The paper baking utensil of claim 1, wherein the snapping portion of the connecting member of each of the connections has a substantially spherical profile.

6. The paper baking utensil of claim 1, wherein
each of the connections further includes a washer mounted on the connecting member and abutting the respective folded edge of the baking body;
the washer of each of the connections abuts the second side of the respective folded edge of the baking body and is located between the snapping portion of the connecting member and the second side of the respective folded edge of the baking body;
each of the folded edges of the baking body is clamped between the fixing portion of the connecting member and the washer of the respective connection.

7. The paper baking utensil of claim 4, wherein the inner board has an annular shape.

8. The paper baking utensil of claim 1, wherein the baking body has a substantially U-shaped cross-sectional profile.

9. A paper baking utensil, comprising:
a baking body;
a plurality of connections mounted on the baking body; wherein:
the baking body is a sheet plate made of paper;
the baking body is bent and folded to have a disk shape;
the baking body has a bottom wall and has an upright peripheral wall surrounding the bottom wall and formed with a plurality of folded edges and a plurality of mounting holes;
any two of the folded edges of the baking body overlap each other;
each of the mounting holes of the baking body is formed in an overlapping portion of any two folded edges of the baking body;
each of the connections is mounted on and extended through a respective one of the folded edges of the baking body so as to support the respective folded edge of the baking body;
each of the connections includes:
a first snapping member abutting a first side of the respective folded edge of the baking body;
a second snapping member abutting a second side of the respective folded edge of the baking body and combined with the first snapping member.

10. The paper baking utensil of claim 9, wherein
the first snapping member of each of the connections has a first end provided with a first locking hook inserted into a respective one of the mounting holes of the baking body and a second end provided with a first press portion abutting the first side of the respective folded edge of the baking body;
the second snapping member of each of the connections has a first end provided with a second locking hook inserted into a respective one of the mounting holes of the baking body and releasably locked onto the first locking hook of the first snapping member and a second end provided with a second press portion abutting the second side of the respective folded edge of the baking body.

11. The paper baking utensil of claim 10, wherein
the first press portion of the first snapping member of each of the connections protrudes outwardly from a first end of the respective mounting hole of the baking body;
the second press portion of the second snapping member of each of the connections protrudes outwardly from a second end of the respective mounting hole of the baking body.
